(19) United States
(12) Patent Application Publication
(10) Pub. No.: US 2010/0209302 A1
(43) Pub. Date: Aug. 19, 2010

(54) Apparatus With A Connection Between Two Capillaries

(76) Inventors: Michael Krummen, Bad Zwischenahn (DE); Hans-Juergen Schlueter, Bremen (DE)

Correspondence Address: THERMO FINNIGAN LLC, 355 RIVER OAKS PARKWAY, SAN JOSE, CA, 95134, US

(21) Appl. No.: 12/668,006

(22) PCT Filed: Jul. 7, 2008
(86) PCT No.: PCT/EP08/05519

§ 371 Date: Apr. 28, 2010

(30) Foreign Application Priority Data
Jul. 6, 2007 (DE) 10 2007 031 678.1

(51) Int. Cl. G01N 30/00; G01N 30/04

(52) U.S. Cl. 422/88; 422/101

(57) ABSTRACT

An apparatus is provided for fluidly coupling a furnace to a gas chromatograph or other device for separating gaseous components. The apparatus includes a first capillary, which forms a reactor tube positioned within the furnace, connected to a second capillary. The capillaries are joined by bonding, adhesion, soldering or pressing in a manner that established a durable, gastight connection.

The invention relates to an apparatus with a furnace for the thermal treatment of gases, a gas chromatograph, or some other device for separating gaseous constituents, arranged upstream and/or downstream of the furnace, and with a connection between two capillaries, which are provided for the onward transfer of an analyte in the gas phase, wherein one of the capillaries is a reactor tube arranged in the furnace.

For the measurement of isotopic ratios or of gaseous substances or substances that have been transformed into a gas phase, the substances or their components, depending on the application, are thermally treated in a reactor, so that simple and easy-to-analyze molecules are produced. The latter can then be analyzed for example with an isotope mass spectrometer.

A typical reactor is a thin tube that is heated from the outside and in which the gas molecules are oxidized, reduced or react in some other way after being supplied with heat. The reactor tube is arranged in a furnace with an insulating wall or is pushed into the furnace. Arranged upstream of the reactor there may be a gas chromatograph, which breaks down the individual constituents of a sample over time and so gradually supplies them to the reactor tube.

Alternatively or in addition, a gas chromatograph or a comparable separating device, for instance a simple separating column, may be arranged downstream of the reactor. The term “gas chromatograph” is to be understood very broadly. The aim is to separate the constituents of a sample of reaction products over time. Preferably, the corresponding device is heatable.

For carrying the gases to the reactor tube and following on after the reactor tube, relatively thin lines are provided. For the sake of simplicity, these lines and the usually comparatively thicker reactor tube are referred to hereafter as capillaries and must be connected to one another in a gastight and reliable manner to achieve reproducible results. Screw connections between the capillaries, in particular where the gases enter the reactor tube and where they leave the same, have been customary so far. The screw connections can be easily released and make it possible for individual capillaries to continue to be used when the other capillaries, respectively, that were previously connected are exchanged. One disadvantage of the known screw connections or other releasable connections in this area is the great risk of leakage, for instance caused by temperature fluctuations and the breaking off of the thin tubes during assembly.

Typical temperature ranges for the operation of gas chromatographs are 20° C. to 250° C., in some cases even 20° to 350°. The reactors are heated more strongly, that is to 500° or more, preferably even much more. To avoid condensate between the gas chromatograph and the reactor, the temperature in this area should not be colder than the highest temperature that the gas chromatograph can reach. Consequently, the connection between the capillary and the reactor in the case of this application must be heat-resistant up to at least 250° C., 350° C., 400° C. or more. The requirements for the heat resistance also depend on where the connecting location is arranged in relation to the heat source of the reactor and to what extent the maximum temperature of the reactor influences the temperature of the connecting location by heat conduction. In any case, extremely high heat resistance must be taken as a basis.

The known screw connections have to meet these extremely high requirements for heat resistance and are correspondingly expensive. The materials used must be selected exactly and must be adapted to the properties of the capillaries with regard to the coefficients of thermal expansion. Only in this way can the required tightness of the connection be ensured under high thermal stress. Even the slightest leaks can falsify the measuring result. In the case of isotopic ratio analysis, the feared fractionation may occur. In addition, further requirements must be taken into consideration, such as avoidance of dead volume and the formation of condensate in the region of the connecting location. Both can lead to a falsification of the measuring results.

It must also be taken into account that the parts that are connected to one another by the connection, that is the capillary as the supply line to the reactor on the one hand and the reactor capillary on the other hand, are typically exposed to different temperature fluctuations. In an analysis sequence, typically the reactor is first heated up, for example from room temperature to 1000° C. Subsequently, the gas chromatograph from which the capillary leads directly to the reactor is controlled or heated up over a certain temperature range, for example between 50° C. and 300° C. To avoid cooling or condensation, a clearance is preferably not provided between the furnace and the chromatograph. After the measurement, a connection may be established between the gas chromatograph and another reactor, for example by way of a switching arrangement. The reactor first used then cools down, while the gas chromatograph, and consequently also the capillary as the supply line to the reactor, continues to fluctuate, or is controlled, between different temperatures. Also for this reason, the thermal stress in the region of the connecting location is considerable. Higher temperatures additionally have problematic effects, since the substances coming from the gas chromatograph may be complex, readily reacting compounds that must not react with the materials used.

A similar problem arises at the outlet of the reactor, that is in the region of a connection between the reactor capillary and the capillary for channeling off the gases converted or produced in the reactor. The thermal stress of the connecting location may be somewhat less in this area if no regulated high temperature is provided thereafter. Also, generally only simple gases leave the reactor.

The object of the present invention is to provide a reliable and durably gastight connection between two capillaries, in particular for the application area described above.

To achieve the object, the apparatus according to the invention is characterized in that the two capillaries are connected to one another by bonding, adhesion, soldering or pressing. The types of connection mentioned may also be combined with one another and lead to a gastight and non-releasable, permanent connection of the capillaries. When the capillary-like reactor tube is exchanged, the capillaries respectively connected to it, which are generally thinner, are also exchanged at the same time. The costs thereby incurred for the thinner capillaries are negligible, or even overcompensated by the then obviated screw connections. The new solution is not only more reliable than the known solution but may also be less costly. The connection of the capillaries is carried out and also tested by the manufacturer, so that erroneous measurements caused by incorrect handling during connection can be ruled out from the outset.

The invention is not restricted to the application area mentioned at the beginning. The only criterion is that capillaries or capillary-like tubes are connected to one another.

The selection of a suitable bonding agent or adhesive agent may be made on the basis of the intended application area. Expected temperatures, pressures, forces, analyte molecules and materials of the capillaries must be taken into consideration.

A connection by pressing primarily means that outer surfaces of the inner capillary are pressed against inner surfaces of the outer capillary, and so a gastight connection is established.

For soldering, the capillaries have at least one metallic or metallized surface. The reactor capillary is preferably produced from a ceramic material, sometimes from metal. Preferably, a reactor tube (the reactor capillary) of ceramic is permanently connected to a capillary of “Silco-Steel”. In this case, the interface, and preferably also part of the inner space, of the reactor capillary may be metallized. The ceramic may be aluminum oxide or aluminum nitride. Aluminum or zirconium oxides or silicon-containing compounds, or any other type of ceramic that can be metallized, are also possible. The metallization is intended to be suitable for soldering and for application to the ceramic. Typical metallization consists, for example, of tungsten, for instance applied by screen printing and burned in, with a layer of nickel on top. If appropriate, further or other metal layers may be present, for example an outer layer of gold, or possibly tin, if soft soldering is desired.

Various types of soldering are possible, for example soft soldering or preferably hard soldering/brazing. Various customary silver, copper and brass solders may be used for this.

As an alternative to soldering with a metallized capillary, so-called active soldering may be used, in which a suitable solder—typically containing titanium, zirconium or hafnium—is connected directly to the ceramic. In this case, two ceramic or other non-metallic capillaries may also be connected to one another. Typical materials for this apart from metal (steel, nickel) and ceramic are various temperature-resistant glasses.

The use of capillaries with inert surfaces, for example the already mentioned Silco-Steel capillaries, is known. Such surfaces may be removed before soldering, for instance by grinding.

According to a further idea of the invention, the connection has at least one overlapping region. This means that, in particular, the capillaries connected to one another overlap one another in the axial direction.

According to a further idea of the invention, the capillaries have different diameters and overlap one another, at least with end regions, the end regions being connected to one another (in the region of the overlap or part of the same). The different diameters make it possible to push the capillaries to be connected into one another and so achieve an overlap.

According to a further idea of the invention or alternatively, end regions of the capillaries are connected to one another by a connecting piece, the connecting piece overlapping the end regions. The connecting piece in this case likewise represents a capillary and is just much shorter than the capillaries to be connected. The connecting piece may respectively cover the capillaries to be connected on the outside in the manner of a sleeve. Alternatively, the connecting piece may be configured as a capillary-like inner tube and be pushed into both end regions of the capillaries to be connected. Finally, given an appropriate diameter of the capillaries to be connected, the connection may take the form that the connecting piece covers over one capillary at the end region and enters the end region of the other capillary.

Advantageously, the capillaries are connected to one another two-dimensionally. The strength and gastightness of the connection are thereby increased. “Two-dimensionally” means that bonding, adhesion or pressing occurs in more than just a punctiform or linear manner. In particular, “two-dimensionally” relates to an extent in the axial direction and at the same time in the circumferential direction.

At least one of the capillaries may consist of ceramic material. In particular, the capillary-like reactor tube, or at least the inner surface thereof, consists of a ceramic material, for example in the case of an H₂ reactor. At least a great heat resistance is an advantage.

Preferably, at least one of the capillaries consists at least partly of metallic material. In particular, an outer surface is metallic. The seal tightness is improved as a result. The connection may also be established by soldering. A metallic inner side is also advantageous, for example with nickel, or so-called glassy carbon, because of the smooth and gastight surface, for instance in the case of a CO reactor.

Advantageously, at least one of the capillaries consists at least partly of quartz glass, an outer and/or inner surface, for example in the case of an H₂ reactor. Synthetic quartz glass or silica glass, also known as fused silica, are particularly well suited. So called Silco Steel capillaries are also well suited.

According to a further idea of the invention, it is provided that a thinner capillary consists of quartz glass and a comparatively thicker capillary consists of ceramic material or a thinner capillary consists of metallic material and a thicker capillary in comparison consists of ceramic material. These are two advantageous pairings of capillary materials.

According to a further idea of the invention, it is provided that at least one of the capillaries has a coating, and that in the overlapping region there is at least partly no coating. Capillaries of fused silica that are coated on the outside with polyimide are known. In the overlapping region, this coating is at least partly not present (any longer). Coatings which react at higher temperatures, with the result that under unfavorable conditions molecules of the coating can get inside the capillaries, are conceivable. Furthermore, it may be better for the function of the bonding agent or adhesive agent for the pressing if the capillary does not have the otherwise present coating at this location.

According to a further idea of the invention, it is provided that the overlapping region has at least one bonding connection or adhesive connection in the region of a coating of one of the capillaries. Bonding agents or adhesive agents are distributed all around the capillary, i.e. in the circumferential direction. In particular, these are gastight bonding agents or adhesive agents. An example of a gastight adhesive is a polyimide-based adhesive. Different adhesives may also be provided in different temperature zones, for example one adhesive for the stability of the connection and one adhesive for the sealing.

According to a further idea of the invention, it is provided that the overlapping region has at least one bonding connection or adhesive connection in the region outside the coating. Here, too, the bonding agent or adhesive agent is preferably provided all around, the agents used being particularly heat-resistant. “Heat resistant” in this sense means that the connection is preserved even under the conditions mentioned in the introductory part, in particular at temperatures of 300° C. to 400° C. or more, for example at more than 600° C. to 800° C. or even over 1000° C. Preferred is a range of over 250° C., in particular over 350° C., or 500° C. to 1600° C.

Advantageously, at least one of the capillaries consists at least partly of noble metal. This is in particular copper, ruthenium, rhodium, palladium, silver, rhenium, osmium, iridium, platinum or gold. Adequate strength is important for the corresponding application area. Non-noble metals may also be used with preference, for example nickel, in particular for reactor tubes.

According to a further idea of the invention, it is provided that in the overlapping region a thinner capillary and a thicker capillary are connected to one another, that the outside diameter of the thinner capillary is greater than/equal to the inside diameter of the thicker capillary—in each case under the same ambient conditions—and that the capillaries are joined together after a thermally induced change in diameter of at least one of the capillaries. This produces a firm connection of the capillaries in the overlapping region under radial pressure in the sense of radial pressing. This type of connection can also be implemented using a capillary-like sleeve or inner tube. This connection may also be implemented without any soldering agent, bonding agent or adhesive agent.

According to a further idea of the invention, it is provided that in the overlapping region surfaces lie one on top of the other, that is an inner side and an outer side, that one of the two surfaces is formed from a hard material with a defined roughness and the other surface is formed from a comparatively softer material, and that the roughness of one surface and the deformability of the material of the other surface are made to match one another in such a way that the softer material has entered the indentations in the rougher material and so there is a particularly gastight connection. Advantageously, one of the capillaries is provided in the overlapping region with a platinum surface and the other capillary is provided with a ceramic surface, preferably in the case of a CO₂ reactor. Of course, the two capillaries may also respectively consist completely of platinum or ceramic material. Platinum is relatively soft in comparison with the ceramic material and, when under pressure—by pressing—fills the rough surface of the ceramic material, so that a particularly snug and gastight connection is produced. The connection may also be implemented without any soldering agent, bonding agent or adhesive agent.

Advantageously, at least one of the capillaries is provided with an inertized surface, in particular on the inside. A reaction with the gas flowing through and/or bonding agent or adhesive agent is then unlikely. A capillary is inertized for example with a Silcosteel coating. Other less reactive surfaces, such as for example platinum, are also favorable.

According to a further idea of the invention, a furnace for the thermal treatment of gases is provided, wherein a reactor tube similar to a capillary and a heater are arranged in a furnace and an insulation is provided, with the reactor tube and/or a capillary being led through the insulation, and the reactor tube and the capillary being connected to one another. The reactor tube has in this case the function of a capillary and is connected in the sense described above to the (other) capillary. Preferably, the reactor tube is respectively connected at both its ends to a thinner capillary.

According to a further idea of the invention, the capillary connected to the reactor tube has an outer coating, in particular of a non-heat-resistant material, preferably such as polyimide, the coating being removed where the capillary reaches into the insulation from the outside. The high temperature prevailing inside the furnace decreases perpendicularly to the insulation up to the outer side. In order as far as possible not to expose the coating to thermal stress, removal of the same to the outside of the insulation of the furnace is advantageous. In this case, there may also be overlapping between the thinner capillary and the reactor tube in the region of the removed coating. The coating is preferably produced from polyimide. Assumed here as heat-resistant is a material that withstands temperatures of at least 300° C., preferably also over 400° C., without reacting and/or significantly losing strength.

Advantageously, the coating ends at a distance from the insulation, in particular in an overlapping region with the reactor tube. The material of the reactor tube may in an unfavorable case be highly heat-conductive, at least better at conducting heat than the insulation. In this case it is advantageous if a region over which heat can be emitted is provided between the insulation and the coating in the axial direction.

In particular, a gas chromatograph is arranged upstream of the furnace. Further devices for the analysis and/or for carrying gas may be provided between the furnace and the gas chromatograph. Alternatively or in addition, a gas chromatograph or a more simple separating device may also be arranged downstream of the furnace.

Advantageously, a mass spectrometer, in particular an isotope mass spectrometer for the determination of isotopic ratios, is arranged downstream of the furnace. Here, too, further devices for the analysis and/or for handling the gases conducted through the capillaries may be provided between the furnace and the mass spectrometer.

Further features of the invention otherwise emerge from the description and from the claims. Advantageously embodiments of the invention are explained in more detail below on the basis of drawings, in which:

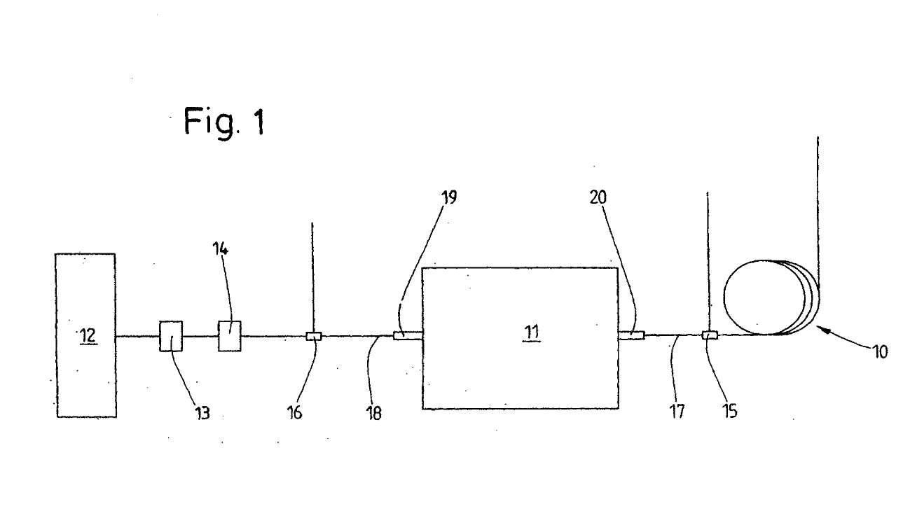

FIG. 1 shows a schematic representation of an apparatus within which a connection of capillaries according to the invention is provided,

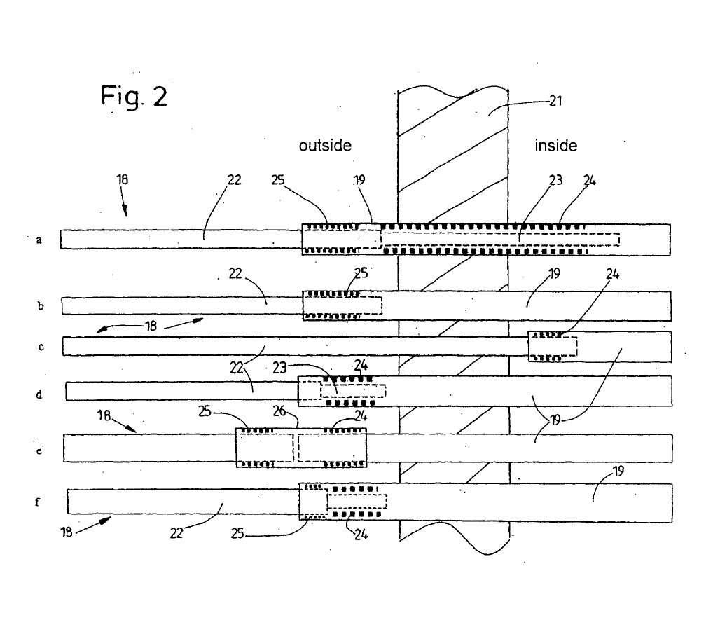

FIG. 2 shows a representation of connections according to the invention in the region of a heat-insulating furnace wall, with the alternative solutions a), b), c), d), e) and f),

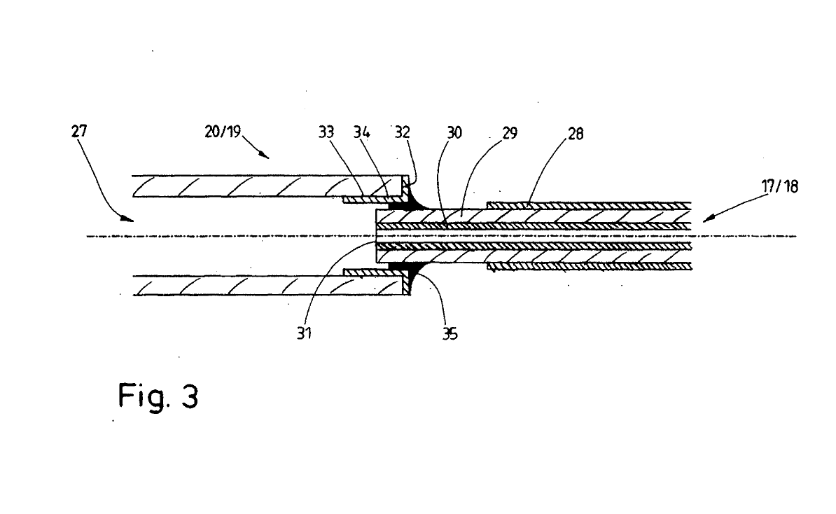

FIG. 3 shows a soldered connection between a reactor capillary metallized at the end and a coated metal capillary, as a supply line to the reactor or as a discharge line from the reactor.

In the mass spectrometric analysis of substances, these substances may be prepared and supplied in various ways. One possibility is to provide a gaseous sample, for instance by employing a gas chromatograph 10, a combustion furnace 11 connected thereto, a mass spectrometer 12 and an interface 13 for the transfer of the gaseous substances into an ion source of the mass spectrometer 12. Such an interface 13 is usually referred to as an open split.

In the gas chromatograph 10, substances contained in a sample are separated from one another over time. In the subsequent furnace 11, an oxidation, reduction, gasification or pyrolysis takes place. The temperatures occurring lie distinctly above the ambient temperature that otherwise acts on the apparatus.

In addition to the parts of the apparatus mentioned, further component parts may be provided, but these are commonplace to a person skilled in the art and do not have to be described in any more detail. For example, a cooling trap 14 may be provided before the interface 13 is reached. Branching arrangements 15, 16 for specific applications and purposes may be arranged upstream or downstream of the furnace 11.

The gaseous substances are carried within the apparatus that is represented in FIG. 1 in capillaries 17, 18. These consist of synthetic quartz glass, which is also referred to as fused silica. A composite with other materials is possible. Preferably, however, here the capillaries 17, 18 consist exclusively of synthetic quartz glass with a coating.

In another embodiment, the capillaries 17, 18 are produced from metallic material, in particular from high-grade steel, which has a surface coating for the purpose of inertizing. Such coatings for steels or high-grade steels are known by the name Silcosteel (registered trademark).

Capillaries are likewise provided within the furnace 11, that is a reactor tube, the ends 19, 20 of which emerge from the furnace 11. The reactor tube usually consists of a ceramic material and, depending on the application, is heated up to approximately 800° C. to 1600° C. Substances that are consumed or can be reactivated may be provided in the reactor tube to promote the oxidation, pyrolysis or other reactions. A thermally assisted reduction of gaseous substances is also possible in the furnace 11.

In the case of known solutions, the capillaries 17, 18 are connected to the ends 19, 20 by screw connections. The aim of this is to make it possible for the reactor tube to be exchanged while retaining the capillaries 17, 18. The known screw connections may, however, cause problems that disturb the analysis considerably. For instance, leaks or dead volumes may occur (in particular in the case of difficulties during assembly).

Instead of the known solution, in the case of the present exemplary embodiment according to the invention the capillaries 17, 18 are connected to the respectively adjacent ends 19, 20 non-releasably, in particular by direct bonding. Adhesives that are known per se, in particular high-temperature adhesives, are suitable as bonding agents. The bonding agents may be selected on the basis of the desired properties, such as grain size of the filler, temperature resistance, elasticity, thermal expansion, etc.

An embodiment with two adhesives of different properties is also preferred. A high-temperature adhesive provides for the connection to be of adequate strength. A further adhesive, for example with polyimide, increases the sealing. The sealing adhesive may also be subsequently injected into the first adhesive.

Instead of the bonding connection, a connection by adhesion may also be provided. In this case, agents for improving the adhesion may be used. Such agents may at the same time also be bonding agents.

Finally, the capillaries 17, 18 may also be connected to the ends 19, 20 by pressing. This is possible in particular when special material pairings are used, for instance with a material that is rough and at the same time hard on the one hand and a material that is comparatively rather soft on the other hand. The surface of the softer material is pressed into the surface of the rougher material. The pressing may be brought about by thermal expansion, for instance by strong cooling of the inner capillaries 17, 18 before they are pushed into the ends 19, 20 and subsequent expansion of the capillaries 17, 18 in dependence on the respective ambient temperature. Metallic capillaries, in particular with a platinum surface, then come to lie against the ceramic surfaces of the ends 19, 20 of the reactor tube from the inside with a sealing effect. Other material pairings are possible and can be determined by tests. When joining them together, it is also possible to proceed in the opposite way. For instance, before joining them together, the respectively outer tube may be strongly heated to increase its diameter. After joining them together, the diameter decreases again, in dependence on the ambient temperature.

Here, the reactor tube (with the ends 19, 20) and the capillaries 17, 18 are thin tubes or lines and for the purposes of the invention are referred to collectively as capillaries, but may have different diameters, as also represented in FIG. 1 and already mentioned. Also possible, however, is the connection of capillaries of approximately the same thickness by tubular (capillary-like) sleeves, which receive in them the ends of capillaries to be connected. Alternatively, inner capillary pieces may connect the ends of two capillaries to one another.

Even in the case of the sleeve-like connection of capillaries (including the inner capillary tube), a wide variety of materials on the one hand and connecting techniques (bonding, adhesion, pressing) on the other hand can be used. Individual examples a) to f) are represented in FIG. 2.

The end 19 of the reactor tube emerges from a heat-insulating wall 21 of the furnace 11, as also represented in FIG. 1, and consists of a ceramic material. The capillary 18 is a fused silica capillary and is provided on the outside with a coating of polyimide. The coated part of the capillary 18 is provided in example a) with the number 22. The coating has been removed from one end 23 of the capillary 18, since here the coating is not heat-resistant. Here, the capillary 18 and the end 19 are bonded to one another twice, that is on the one hand with a bonding location 24 between the non-coated end 23 and the end 19. In this case, the bonding location 24 preferably lies in the interior of the furnace 11 and is formed by a high-temperature adhesive. A second bonding location 25 is formed between the end 19 and the coated part 22 outside the insulation 21. The bonding agent may be less heat-resistant here. Preferably, a bonding agent that is adapted to the properties of the coating, in particular a polyimide adhesive, is used.

The reactor tube may have a much greater heat conductivity than the insulating wall 21. Heat is then led out from the furnace 11 by way of the ends 19, 20. In order to reduce the thermal stress for the capillary 18 or the coating, the end 19 extends a significant way out of the wall 21. Furthermore, the coated part 22 of the capillary 18 only reaches a short way into the end 19, so that the coated part 22 ends before the wall 21 is reached. The distance may be several centimeters. By contrast, the non-coated end 23 with the bonding location 24 may be located inside the furnace 11 or else level with the insulating wall 21.

The connection of the capillary 17 to the end 20 may be formed by analogy with the previous embodiments. However, thermally insensitive materials are also to be preferred here for the capillary 17 and the corresponding bonding agents because of the possible higher temperatures following the gas chromatograph 10.

On account of the described bonding between the capillaries 17, 18 and the ends 19, 20, these connecting locations are reliable and durably tight. The reactor tube and capillaries 17, 18 are connected to another non-releasably and, if and when required, are exchanged together. Releasable connections or branching arrangements are provided for this purpose between the capillary 17, 18 on the one hand and the branching arrangements 15, 16 on the other hand. Such releasable connections are known in principle and do not require any further explanation. Alternatively, the capillaries 17, 18 may also be coupled to the gas chromatograph 10 on the one hand and the cooling trap 14 on the other hand, or to further component parts of the apparatus, by way of releasable connections.

In example b) of FIG. 2, the capillary 18 only has the bonding location 25 lying on the outside in relation to the wall 21. A coating may be provided, but does not have to be. The capillary 18 ends outside the wall 21 at a distance from it, by analogy with the coated part 22 in example a).

If a highly heat-resistant capillary 18 is used, it may also be led through the wall 21 into the furnace 11 and end there, see example c). Correspondingly, the end 19 of the reactor tube does not reach as far as the wall 21 in the interior of the furnace 11. The provided bonding location 24 is highly heat-resistant.

In the same way as in example a), in example d) the capillary 18 has a coated part 22 and an end 23 without coating. Here (example d), however, only the non-coated end 23 extends with a small portion of the coated part 22 into the end 19 and ends before the wall 21 is reached. The end 23 and the end 19 are connected in the region of the (single) bonding location 24 by a highly heat-resistant adhesive.

Example e) shows the connection of the capillary 18 to the end 19 using a tubular sleeve 26. Preferably, the capillary 18 and the end 19 are formed with the same outside diameter. Alternatively, the sleeve 26 may have different inside diameters at its two ends. The sleeve 26 is bonded on both sides to the ends 18 and 19 respectively lying inside, see bonding locations 24, 25. The end 19 extends through the wall 21, so that the sleeve 26 is arranged outside the furnace 11, at a distance from the wall 21. The sleeve 26 consists of highly temperature-resistant plastic or other suitable materials.

Finally, example f) shows a modification of example d)—depending on how it is viewed also of example a)—that is with a second bonding location 25 between the coated part 22 and the end 19, as also in example a). However, both bonding locations 24, 25 lie outside the wall 21, by analogy with example d).

FIG. 3 shows a soldered or bonded connection between the end 19 or 20 of a reactor capillary 27 on the one hand and a thinner capillary 17 or 18 as a supply line to the reactor or discharge line from the reactor on the other hand. For the sake of simplicity, hereafter reference is only made to the capillary 17, the end 20 and a soldered connection.

The capillary 17 is a coated metal capillary, preferably of steel. An outer coating 28 has been removed in the connecting region, so that a metallic core layer 29 is exposed on the outside. An inner coating 30 may extend up to the open end face 31 of the capillary 17. The coatings 28, 30 protect the metallic core layer 29.

The end 20 or the reactor capillary 27 consists of ceramic material and is provided at the end, that is in the end region 32 and in the inner region 33 adjacent thereto, with a metallic coating 34. Depending on the soldering method, this coating preferably consists of tungsten, nickel, gold and/or tin.

The capillary 17 has been pushed with its end a short way into the end 20, so that there is a short overlap. In the region of the transition between the end region 32 and the inner region 33, the capillary 17 and the end 20 are connected to one another by a peripheral soldering location 35 (represented as blackened) in a durably gastight and non-releasable manner. This is preferably a hard-soldered connection, for instance with silver or brass solder. Also possible, however, are a soft-soldered connection or an actively soldered connection, in which the metallic coating 34 is not required, or a bonding.

What is claimed is:

1. An apparatus, comprising:
a furnace for the thermal treatment of gases;
a device for separating gaseous constituents, fluidly coupled to the furnace;
first and second capillaries joined by a connection for conveying an analyte in the gas phase, wherein the first capillary is a reactor tube arranged in the furnace; and
wherein the first and second capillaries are connected to one another in a durably gastight manner by at least one of bonding, adhesion, soldering or pressing.

2. The apparatus as claimed in claim 1, wherein the connection has at least one overlapping region.

3. The apparatus as claimed in claim 1, wherein the first and second capillaries have different diameters and have connecting end regions positioned in overlapping relation.

4. The apparatus as claimed in claim 1, wherein end regions of the first and second capillaries are connected to one another by a connecting piece, the connecting piece overlapping the end regions.

5. The apparatus as claimed in claim 1, wherein the first and second capillaries are connected to one another two-dimensionally.

6. The apparatus as claimed in claim 1, wherein at least one of the capillaries consists of ceramic material.

7. The apparatus as claimed in claim 1, wherein at least one of the capillaries consists at least partly of metallic material.

8. The apparatus as claimed in claim 1, wherein at least one of the capillaries consists at least partly of quartz glass.

9. The apparatus as claimed in claim 1, wherein one of the capillaries is a thinner capillary formed of one of quartz glass or a metallic material, and the other capillary is a comparatively thicker capillary formed of ceramic material.

10. The apparatus as claimed in claim 2, wherein at least one of the capillaries has a coating the coating being absent in at least part of the overlapping region.

11. The apparatus as claimed in claim 2, wherein the overlapping region has at least one bonding connection or adhesive connection in the region of a coating of one of the capillaries.

12. The apparatus as claimed in claim 10, wherein the overlapping region has at least one bonding connection or adhesive connection in the region outside the coating.

13. The apparatus as claimed in claim 1, wherein the first and second capillaries are bonded together using a first bonding agent for a strong connection and a second bonding agent, different from the first bonding agent, for a gastight connection.

14. The apparatus as claimed in claim 7, wherein at least one of the capillaries consists at least partly of precious metal.

15. The apparatus as claimed in claim 2, wherein one of the capillaries is a thinner capillary having an outside diameter and the other capillary is a thicker capillary having an inside diameter, the outside diameter being larger than the inside diameter when the capillaries are maintained at the same temperature, and wherein the capillaries are joined together after a thermally induced change in diameter of at least one of the capillaries.

16. The apparatus as claimed in claim 2, wherein one of the capillaries has a surface in the overlapping region that is formed from a material that is softer and more deformable relative to the corresponding surface of the other capillary, such that mating of the surfaces produces a gastight connection.

17. The apparatus as claimed in claim 16, wherein one of the capillaries has in the overlapping region a platinum surface and the other capillary has a ceramic surface.

18. The apparatus as claimed in claim 1, wherein one of the capillaries is at least partially fabricated of nickel.

19. The apparatus as claimed in claim 1, wherein at least one of the capillaries has an inertized surface.

20. The apparatus as claimed in claim 1, wherein a heater is arranged in the furnace and an insulation is provided, with at least one of the reactor tube and one capillary being led through the insulation, and the reactor tube and the other capillary being connected to one another.

21. The apparatus as claimed in claim 20, wherein the one capillary is led through the insulation, and wherein the capillary has an outer coating removed where the capillary reaches into the insulation from the outside.

22. The apparatus as claimed in claim 21, wherein the coating ends at the overlapping region with the reactor tube.

23. The apparatus as claimed in claim 1, wherein a mass spectrometer is arranged downstream of the furnace.
